(19) United States
(12) Patent Application Publication
(10) Pub. No.: US 2007/0256960 A1
(43) Pub. Date: Nov. 8, 2007

(54) Material Separator

(75) Inventor: Dale Dees, McGuireville, AZ (US)

Correspondence Address: BOOTH UDALL, PLC, 1155 W. Rio Salado Pkwy., Suite 101, Tempe, AZ, 85281, US

(73) Assignee: BLUE LINE FABRICATION, INC., McGuireville, AZ (US)

(21) Appl. No.: 11/421,648

(22) Filed: Jun. 1, 2006

Related U.S. Application Data
(60) Provisional application No. 60/746,314, filed on May 3, 2006.

(51) Int. Cl. B07B 1/49

(52) U.S. Cl. 209/393

(57) ABSTRACT

A method and apparatus for separating material are described. The material separator may include a frame comprising a base supporting a slanted grate deck and at least one reducer grate deck removably and pivotally coupled to the slanted grate deck. The method may include: removably and pivotally placing a removable reducer grate deck on a slanted grate deck; depositing excavated material on the removable reducer grate deck such that the material is separated by passing through both the removable reducer grate deck and the slanted grate deck; and releasing clogged material between grate bar members of the reducer grate deck and the slanted grate deck by engaging at least one internal bumper of the reducer grate deck with the moving equipment to push a free, non-pivoting end of the reducer grate deck upwards to release the clogged material.

### CROSS REFERENCE TO RELATED APPLICATION

This application claims priority to U.S. Provisional Patent Application to Dale Dees entitled “Material Separator,” Ser. No. 60/746,314, filed May 3, 2006, now pending, the disclosure of which is incorporated entirely herein by reference.

### BACKGROUND

A. Technical Field

This document relates to a material separator.

B. Background Art

The separation of material has been performed by utilizing a number of conventional methods and apparatus. However, many conventional methods and apparatus are inefficient at separating material and are not self cleaning. Additionally, many conventional methods and apparatus must utilize manpower versus operating equipment to manipulate, place, position, and the like different components of the separating apparatuses during various phases of separation processes. When the equipment operator has to get of the equipment to undertake these actions, the result is lost labor and equipment operating time, inconvenience, increased costs, and decreased separated material production.

### SUMMARY

In an aspect, this document features a material separator. The material separator may include a frame comprising a base supporting a slanted grate deck and at least one reducer grate deck removably and pivotally coupled to the slanted grate deck.

Implementations may include one or more of the following.

The reducer grate deck may comprise two opposite side members, two opposite end members, and a plurality of grate members located between the opposite end members.

The slanted grate deck may have two opposite end members and a plurality of grate members located between the opposite end members, and the grate members of the reducer grate deck may be one of: positioned above the grate members of the slanted grate deck; nested between the grate members of the slanted grate deck to form a substantially unitary, flush decking; and nested between the grate members of the slanted grate deck to form a unitary, flush decking.

The grate members of the reducer grate deck and the grate members of the slanted grate deck may be substantially diamond shape in cross-section. The grate members of the reducer grate deck may be of a different size than the grate members of a slanted grate deck.

The reducer grate deck may be removably and pivotally coupled to the slanted grate deck by at least one catch member removably and pivotally engaging the upper end member of the slanted grate deck. The at least one catch member may be one of: two spaced apart catch members coupled to and extending from the upper end member of the reducer grate deck; a plurality of spaced apart catch members coupled to and extending from the upper end member of the reducer grate deck; one long catch member coupled to and extending from the upper end member of the reducer grate deck, the catch member extending along a substantial portion of the upper end member of the reducer grate deck; and at least one catch member integrally joined with the upper end member of the reducer grate deck. The at least one catch member may be at least one angle catch member, one side coupled to the upper end member of the reducer grate deck and the other side engaging the upper end member of the slanted grate deck.

The reducer grate deck may further comprise at least one internal bumper. The at least one internal bumper may comprise at least one angled internal bumper that is slidably engageable with moving equipment. The at least one internal bumper may be coupled to a lower portion of at least one grate member of the reducer grate deck. The at least one internal bumper may comprise two spaced apart internal bumpers coupled to lower portions of two different grate members of the reducer grate deck.

At least one seating tab may be coupled to each of the opposite side members of the reducer grate deck. Each at least one seating tab may extend outwardly at a downward angle from the side member. The at least one seating tab may comprise two pairs of spaced apart seating tabs, each pair coupled on a different side member.

At least one external pick up member may be coupled to the reducer grate deck.

Two lift members may be included extending downwardly from an upper end portion of the slanted grate deck and a cross member removably coupled to free ends of the lift members.

The base may comprise a front wall, two opposite side walls, and an open back. The front wall may comprises a double plated front wall having an inside wall plate and an outside wall plate. The two side walls may each comprise at least one rigging member.

In another aspect, this document features a material separator. The material separator may include a frame comprising a base comprising: a front wall and two opposing side walls, the two side walls each comprising at least one rigging member; two upright back supports, one extending upward from a back end of one sidewall and the other extending upward from a back end of the other sidewall; and a slanted grate deck extending from upper portions of the upright supports down to an upper portion of the front wall.

Implementations may include one or more of the following. The at least one rigging member may comprise a pair of spaced apart rigging members at an upper portion of each side wall. The rigging members may each comprise one of a hole, a ring, a channel section, and a hook.

In another aspect, this document features a material separator. The material separator may include a frame comprising: a base comprising a front wall and two opposing side walls, and two upright back supports, one extending upward at a back end of one sidewall and the other extending upward at a back end of the other sidewall; a slanted grate deck extending from upper portions of the upright back supports down to an upper portion of the front wall; two lift members extending downwardly from an upper end portion of the slanted grate deck; and a cross member removably coupled to free ends of the lift members.

Implementations may include one or more of the following. The slanted grate deck may further comprise an upper end member coupled to and separating upper portions of the upright back supports, and the lift members may be located spaced apart along the upper end member between the upright back supports. The slanted grate deck may further comprise a plurality of grate members, and the two lift members may be located on upper portions of two separate grate members respectively.

In an aspect, this document features a method for separating material. The method may include: positioning a frame having a base and a slanted grate deck on a ground; removably and pivotally placing a removable reducer grate deck on the slanted grate deck; depositing excavated material on the removable reducer grate deck such that the material is separated by passing through both the removable reducer grate deck and the slanted grate deck; and releasing clogged material between grate bar members of the reducer grate deck and the slanted grate deck by engaging at least one internal bumper of the reducer grate deck with the moving equipment to push a free, non-pivoting end of the reducer grate deck upwards to release the clogged material.

Implementations may include one or more of the following.

The step of releasing clogged material may comprise releasing clogged material between grate bar members of the reducer grate deck and the slanted grate deck by slidably engaging at least one internal bumper of the reducer grate deck with the moving equipment to slidably push a free, non-pivoting end of the reducer grate deck upwards to release the clogged material.

The step of releasing clogged material may further comprise continuing to drive the moving equipment forward past the at least one bumper so that the reducer grate deck falls back into position further shaking loose or crushing any remaining clogged materials.

The step of releasing clogged material may further comprise collecting released clogged material that falls through the reducer grate deck and the slanted grate deck with the moving equipment.

The step of releasing clogged material may further comprise automatically repositioning the reducer grate deck back on the slanted grate deck as it falls back using at least one seating tab located on each side member of the reducer grate deck.

The step of removably and pivotally placing may comprise removably and pivotally placing a removable reducer grate deck on the slanted grate deck by engaging a pair of spaced apart external pick up members with moving equipment.

The step of removably and pivotally placing may comprise removably and pivotally placing a removable reducer grate deck on the slanted grate deck by automatically positioning the reducer grate deck on the slanted grate deck using at least one seating tab located on each side member of the reducer grate deck.

The step of removably and pivotally placing may further comprise holding the removable reducer grate deck on the slanted grate deck by at least one catch member.

The step of removably and pivotally placing may further comprise one of: positioning grate members of the reducer grate deck in a raised position above grate members of the slanted grate deck; nesting grate members of the reducer grate deck between grate members of the slanted grate deck to form a substantially unitary, flush decking; and nesting grate members of the reducer grate deck between grate members of the slanted grate deck to form a unitary, flush decking.

The foregoing and other aspects and implementations may have one or more or all of the following advantages. Implementations are simple by design, easy to manufacture and repair, and works every time. Implementations are efficient, reliable, and durable in separating material and are self cleaning. Additionally, implementations are able to utilize operating equipment versus manpower to place, position, and change out reducer screen decks and to pivot reducer screen decks. Implementations are the first self cleaning material separators; any plug-ups can be easily removed without an operator having to get off of his equipment. Thus, implementations keep equipment operators on their equipment (a single operator never has to get out of his seat) during all phases of separation processes, including unclogging or cleaning the material separators, resulting in no lost labor and equipment operating time, convenience, decreased costs, and increased separated material production.

The foregoing and other aspects, implementations, features, and advantages will be apparent from the DESCRIPTION and DRAWINGS, and from the CLAIMS.

### DRAWINGS

Implementations will hereinafter be described in conjunction with the appended DRAWINGS (which are not necessarily to scale), where like designations denote like elements.

FIG. 1 is a back perspective view of a material separator implementation.

FIG. 2 is a front perspective view of the material separator implementation of FIG. 1.

FIG. 3 is side view of the material separator implementation of FIG. 1.

FIG. 4 is a front perspective view of a frame of the material separator implementation of FIG. 1.

FIG. 5 is a front perspective view of a portable, interchangeable reducer grate deck of the material separator implementation of FIG. 1.

FIG. 6 is a broken away back perspective view of the material separator implementation of FIG. 1 depicting the marriage of the frame and the portable, interchangeable reducer grate deck.

FIG. 7 is a cross section view taken along line 7-7 of FIG. 6.

FIG. 8 is a cross section view similar to FIG. 7 of another material separator implementation.

FIGS. 9-16 are various side and perspective views of the material separator implementation of FIG. 1 during use.

### DESCRIPTION

### A. Structure

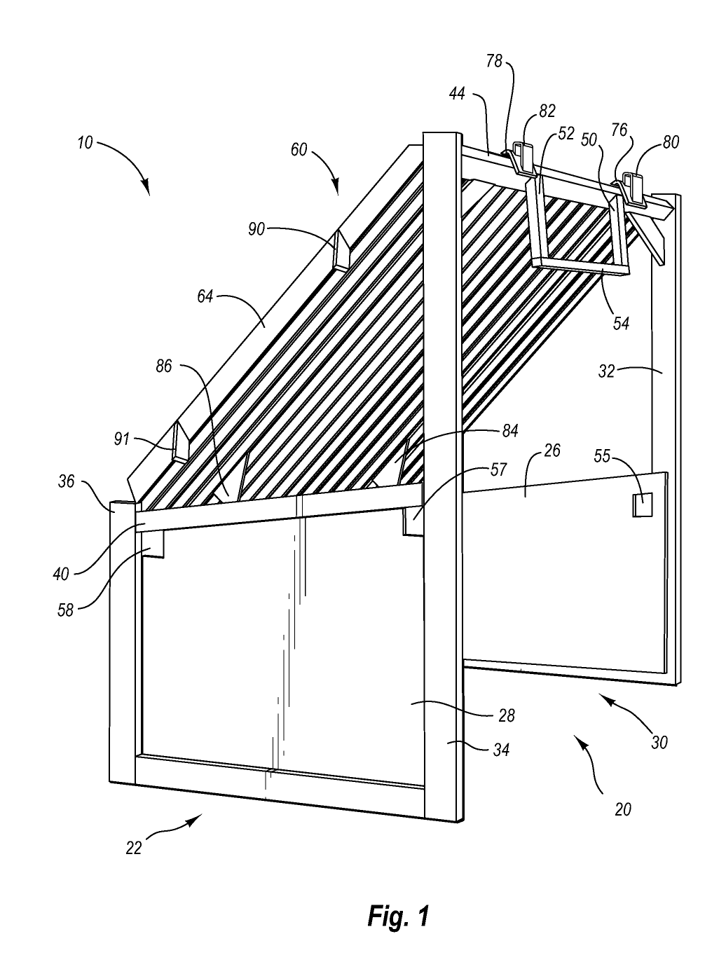

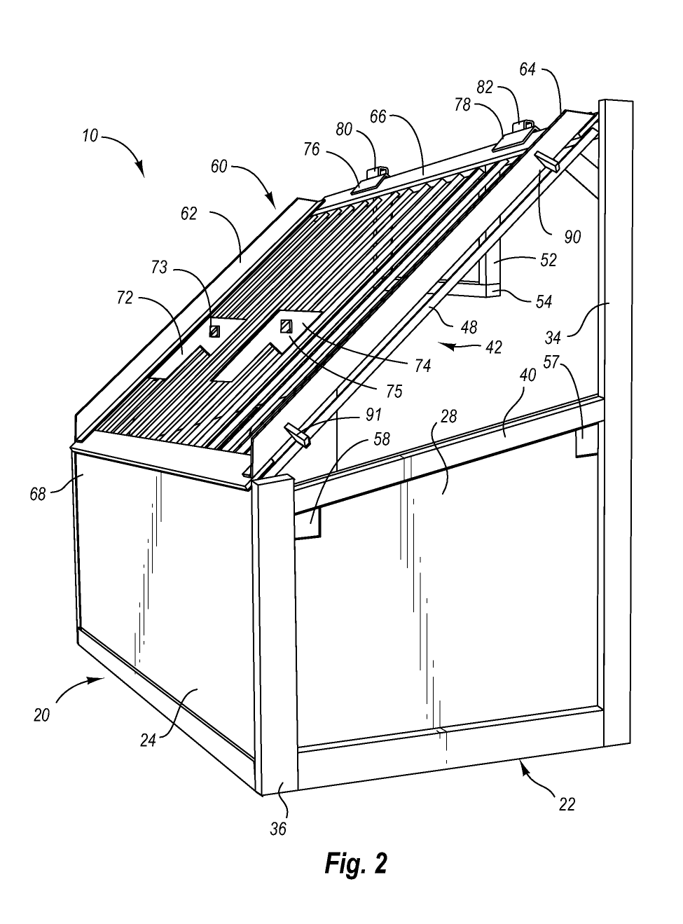

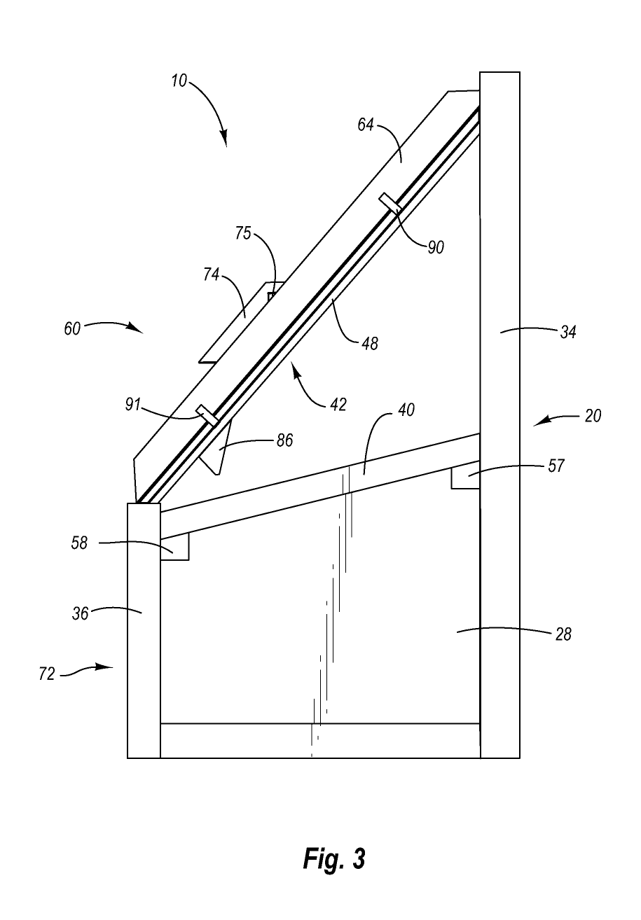

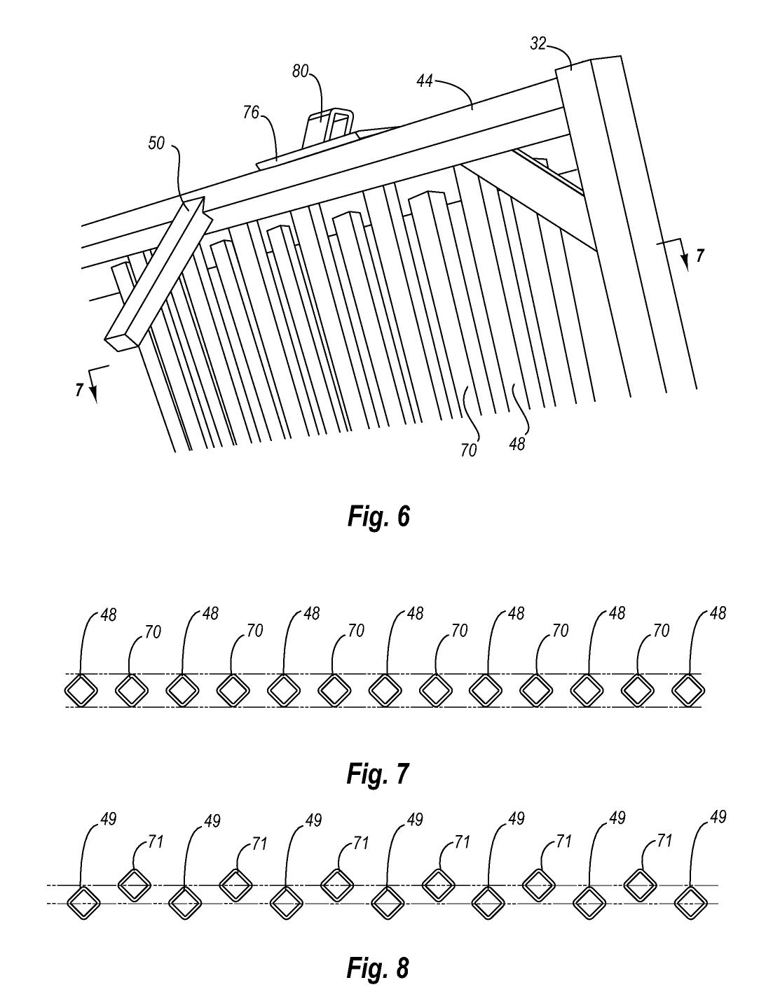

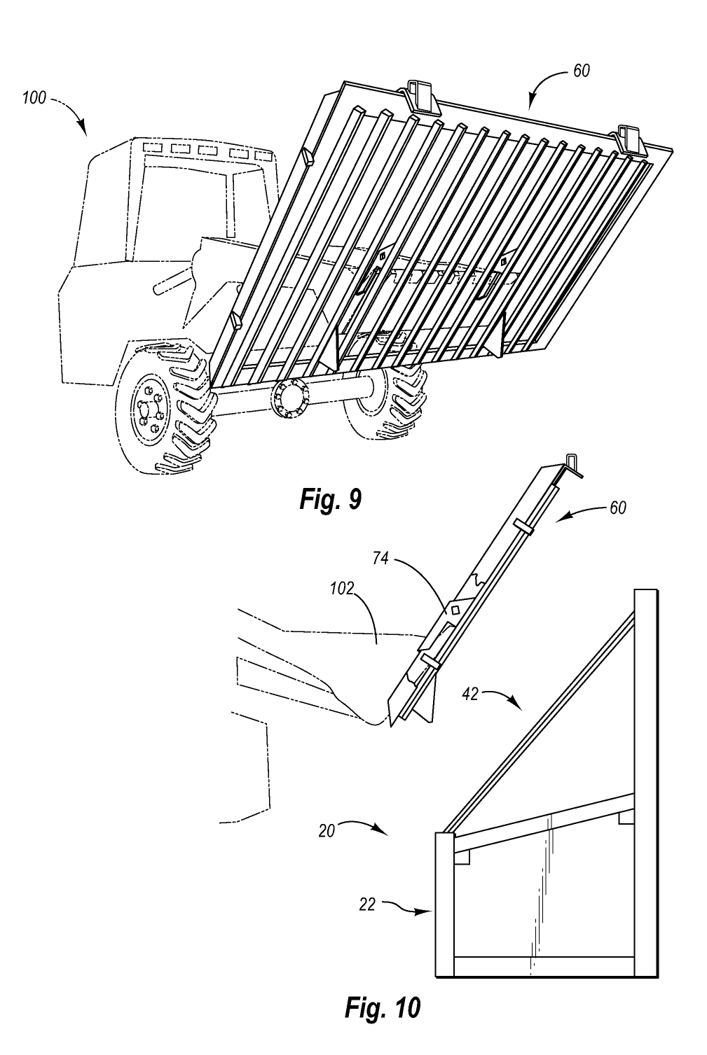

There are a variety of material separator implementations. Notwithstanding, with reference to FIGS. 1-7 and for the exemplary purposes of this disclosure, a material separator implementation is depicted. Material separator 10 includes: a frame 20 comprising a base 22 supporting a slanted grate deck 42; and at least one portable, interchangeable reducer grate deck 60 that is configured to removably couple with slanted grate deck 42.

More specifically, frame 20 comprises box-like base 22 that includes: front wall 24, two opposite side walls 24 and 26, open back 30, a pair of slanted side support members 38 and 40, a pair of spaced apart upright front supports 35 and 36, and a pair of spaced apart upright back supports 32 and 34. The lower portions of the pair of upright back supports 32 and 43 are coupled opposite one another to the back ends of the opposite side walls 26 and 28, respectively. Slanted side support members 38 and 40 extend between upright front support 35 and upright back support 32 and upright front support 36 and upright back support 34, respectively. Slanted side support members 38 and 40 are adjacent the upper portions of sidewalls 26 and 28, respectively, with the tops of slanted side support members 38 and 40 flush with or below the tops of sidewalls 26 and 28, respectively. Slanted side support members 38 and 40 prevents material (material that can fall of when the material separator is being transported later) from building up on their top surfaces—more easily shed material off.

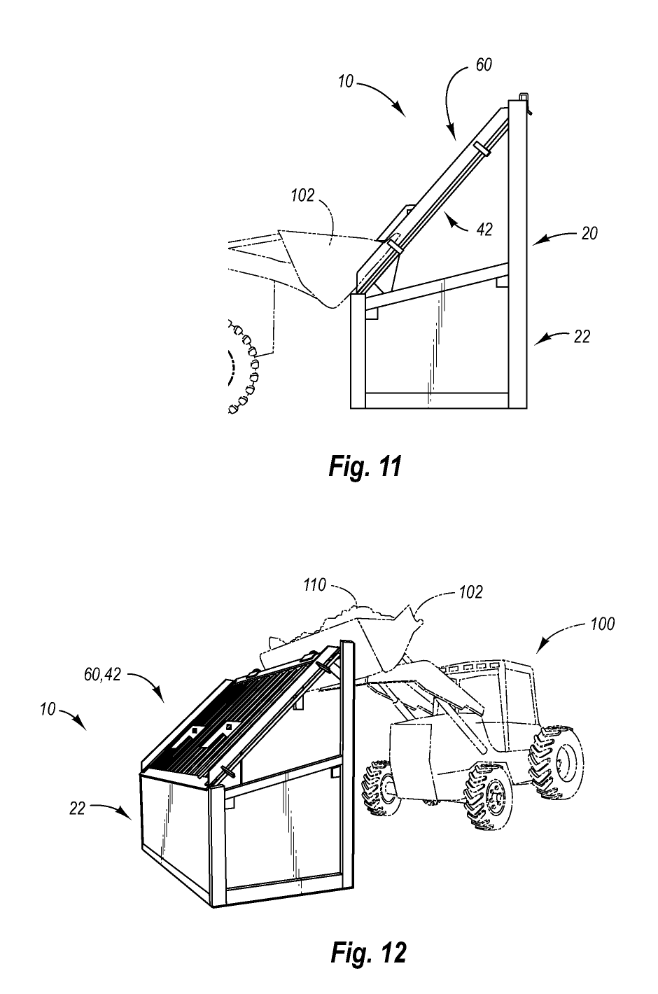

Frame 20 also comprises slanted grate deck 42 coupled between the pair of spaced apart upright front supports 35 and 36 and the pair of spaced apart upright back supports 32 and 34. Slanted grate deck 42 has two opposite end members 44 and 46 and a plurality of grate members 48 located between opposite end members 44 and 46. Upper and lower end members 44 and 46 respectively of slanted grate deck 42 may be coupled to and separate the upper portions of upright back supports 32 and 34 and the upper portions of upright front supports 35 and 36 along the upper portion of front wall 24. Grate members 48 may have a diamond shape in cross-section (see FIG. 7). Such a configuration gives strength in both the vertical and horizontal directions and eliminates the need for any extra supports for slanted screen deck 42. Such a configuration also provides a more efficient and strong interface (e.g., sharper edges of grate members 48 as opposed to flat sides) to break up and separate material. Additionally, such a configuration creates multiple funnels/channels between grate members 48 to more efficiently collect and separate material; more of the material that is placed on slanted grate deck 42 is separated, while less is shed off the surface. In the end, this helps the operator to be more efficient and to maximize the separation of material.

Frame 20 may also include at least one lift member. For example, lift members 50 and 52 are shown extending downwardly from the upper end portion of slanted grate deck 42 in order to enable transport and movement of frame 20 or material separator 10 with a front end bucket of a backhoe, a front end loader, or the like for example as described below. Lift members 50 and 52 may be located spaced apart along upper end member 44 between upright supports 32 and 34. Lift members 50 and 52 may alternatively be located on the upper portions of two separate grate members 48. In addition, cross member 54 may be included that is removably coupled to the ends of lift members 50 and 52 by any appropriate fastening mechanisms to further facilitate the transport and movement of frame 20 or material separator 10 with a bucket of an excavator or the like.

Frame 20 may also include at least one rigging member to further facilitate the transport and movement of frame 20 or material separator 10 by an excavator or the like or to provide tie-down points for frame 20 when it is being transported on a truck for example from job site to job site. The rigging members accommodate and/or removably couple with any appropriate cables, swings, chokers, chains, and/or the like that may be used in conjunction with an excavator, truck , or the like. For example, a pair of spaced apart rigging members 55 and 56 and a pair of spaced apart rigging members 57 and 58 are shown, and they may be located on sidewalls 26 and 28, respectively, in the corners that are formed between upright back and front supports 32 and 35 and slanted side support member 38 and upright back and front supports 34 and 36 and slanted side support member 40 respectively. In this implementation, for example, rigging members 55, 56, 57, and 58 are holes through sidewalls 26 and 28.

Portable, interchangeable reducer grate deck 60 includes two opposite side members 62 and 64, two opposite end members 66 and 68, and a plurality of grate members 70 located between opposite end members 66 and 68. Grate members 70 may have a diamond shape in cross-section (see FIG. 7). Such a configuration gives strength in both the vertical and horizontal directions and eliminates the need for any extra supports for reducer grate deck 60. Such a configuration also provides a more efficient and strong interface (e.g., sharper edges of grate members 70 as opposed to flat sides) to more easily break up and separate material. Additionally, such a configuration creates multiple funnels/channels between grate members 70 and grate members 48 to more efficiently collect and separate material; more of the material that is placed on the reducer grate deck 60/slanted grate deck 42 combination is separated, while less is shed off the surface. In the end, this helps the operator to be more efficient and to maximize the separation of material.

Grate members 70 may be substantially parallel with the opposite side members 62 and 64, but could be placed in other orientations depending upon the orientation of grate bars 42 of slanted grate deck 42 for example. Regardless, when reducer grate deck 60 is installed on slanted grate deck 42, grate members 70 mesh or nest between grate members 48 to form a unitary, flush decking as can be seen from the cross section in FIG. 7.

Reducer grate deck 60 may also include at least one external pick up member. For example, two external pick up members 72 and 74 are shown that attach to the tops or sides of two different grate members 70 so that a front end bucket of a backhoe may engage them and lift and move reducer grate deck 60 as described below.

Reducer grate deck 60 may also include at least one catch member capable of removably and pivotally engaging upper end member 44 of slanted grate deck 42 allowing pivoting of reducer grate deck 60 when unclogged material needs to be released. For example, two spaced apart catch members 76 and 78 are shown coupled to and extending from upper end member 66 of reducer grate deck 60. Catch members 76 and 78 may each be an angle member, one side coupled to upper end member 66 and the other side fitting around the outer perimeter of upper end member 44 of slanted grate deck 42 when reducer grate deck 60 is properly positioned in frame 20.

Reducer grate deck 60 may also include at least one internal bumper configured to engage a front end bucket of a backhoe for example to help clear any clogged material on/in reducer grate deck 60. For example, two internal bumpers 84 and 86 are shown attached to the bottoms or sides of two different grate members 70. The grate members 70 may be the same grate members to which pick up members 72 and 74 are attached, or they may be different grate members, such as adjacent grate bar members. Bumpers 84 and 86 may be triangular or rectangular in shape for example. Triangular shaped bumpers 84 and 86 are actually shown and serve many useful purposes. The front end bucket of a backhoe just needs to be aligned with bumpers 84 and 86 and then the backhoe just needs to drive forward to slidably push the free, non-pivoting end of reducer grate deck 60 upwards to clear any clogged materials as described below and depicted in FIG. 15. Continuing to drive the backhoe forward allows bumpers 84 and 86 to slip inside of the bucket and reducer grate deck 60 to fall forcefully back into position, further shaking loose or crushing any lingering clogging materials. Additionally, the bucket is in a position to catch any released clogging material that may fall through the decking so it can be reprocessed if desired or discarded, thereby preventing released clogging material from mixing with the previously separated finer material.

Reducer grate deck 60 may also include at least one seating tab on each of opposite side members 62 and 64 that help align and seat reducer grate deck 60 on slanted grate deck 42 during installation of the same or when using a front end bucket of a backhoe for example to engage bumpers 84 and 86 and push the free, non-pivoting end of reducer grate deck 60 upwards to clear any clogged materials (i.e. keep reducer grate deck 60 centered with slanted grate deck 42 so as to not change the spacing between grate members 48 and 70 and ultimately the size of screened material). For example, two pairs of seating tabs are shown, namely, spaced apart seating tabs 88 and 89 coupled on side member 62 and spaced apart seating tabs 90 and 91 coupled on side member 64. Seating tabs 88, 89, 90, and 91 all extend outwardly at a downward angle from side members 62 and 64, respectively.

Reducer grate deck 60 may also include at least one rigging member to further facilitate the transport and movement of reducer grate deck 60 by an excavator or the like or to provide tie-down points for reducer grate deck 60 when it is being transported on a truck for example from job site to job site. The rigging members accommodate and/or removably couple with any appropriate cables, swings, chokers, chains, and/or the like that may be used in conjunction with an excavator, truck, or the like. For example, as depicted, rigging members 80 and 82 may be located on catch members 76 and 78 respectively (or spaced apart along upper end member 66 for example) and rigging members 73 and 75 may be located on external pick up members 72 and 74 respectively (or spaced apart along lower end member 68 for example). In this implementation, for example, rigging members 73 and 75 are holes through pick up members 72 and 74, respectively, while rigging members 80 and 82 are upside down U-or J-shaped channel sections coupled to catch members 76 and 78, respectively.

### B. Other Implementations

Many additional implementations are possible in addition to those previously discussed.

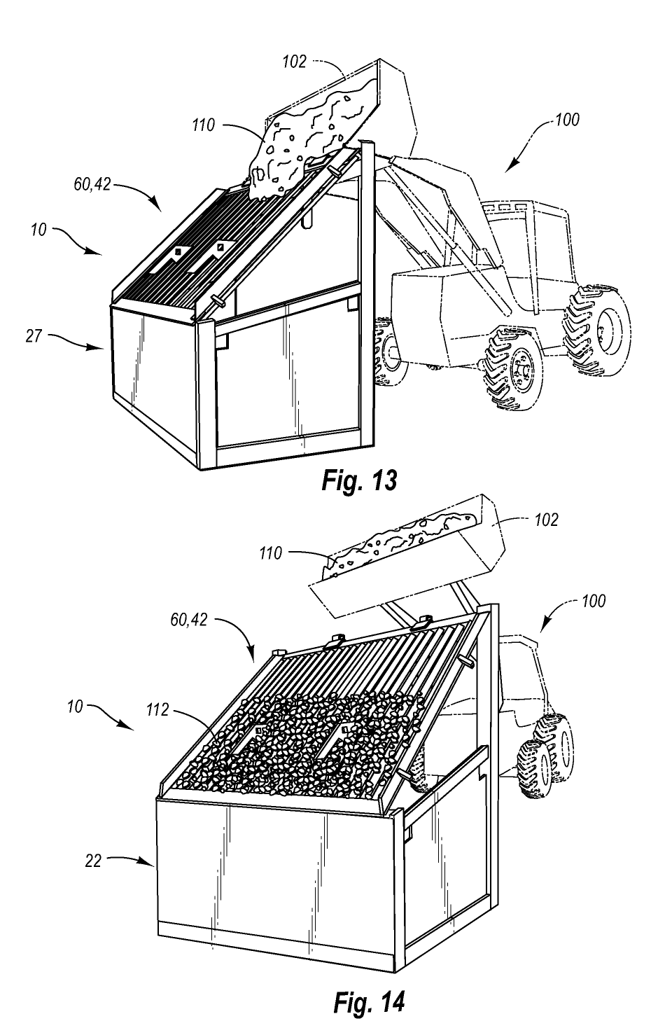

For the exemplary purposes of this disclosure, other material separator implementations may comprise a substantially unitary, flush decking arrangement, as opposed to the unitary, flush decking arrangement depicted in FIG. 7. In particular and referring to FIG. 8, grate members 71 partially (e.g., about half of the member) mesh or nest between grate members 49 to form a substantially unitary, flush decking. Alternatively, grate members of a reducer grate deck may not mesh or nest (e.g., no overlap at all) between grate members of a slanted grate deck, but are instead in a raised position above the grate members of a slanted grate deck.

For the exemplary purposes of this disclosure, still other material separator implementations may comprise grate members of a reducer grate deck of a different size (e.g., larger or smaller) than grate members of a slanted grate deck. For example, if there is a wide spacing between grate members of a slanted grate deck, two or more reducer grate decks may be provided with grate members of a different size (e.g., larger or smaller) than the grate members of the slanted grate deck so as to provide for screened material across a range of various sizes.

For the exemplary purposes of this disclosure, yet other material separator implementations may comprise a double sided or plated front wall. The double sided front wall may comprise a U-shaped or H-shaped base member, an inside wall plate and an outside wall plate coupled to the inside surfaces of the side walls of the U-shaped or H-shaped base member, and at least one (e.g., two) internal upright support members separating the inside wall plate and the outside wall plate. Such a double sided front wall not only prevents material from building up on exposed surfaces (material that can fall of when the material separator is being transported) but it provides protection from wall damage due to a bucket of a backhoe maneuvering inside the base of the frame.

For the exemplary purposes of this disclosure, even other material separator implementations may comprise one longer, angled catch member, a plurality of shorter angled catch members, and the like. Additionally, the upper end member itself of the reducer grate deck could function as a catch member or catch members. That is, for example, the upper end member itself may be an angle catch member or may have one or more integral flanges.

For the exemplary purposes of this disclosure, still other material separator implementations may comprise rigging members other than holes or channel sections for example, such as rings, eyelets, hooks, clips, and/or any other suitable rigging mechanisms. Additionally, a plurality of rigging members may be included positioned at different locations on the sidewalls of the base for example.

For the exemplary purposes of this disclosure, yet other material separator implementations may comprise portable, interchangeable slanted screen decks. These portable, interchangeable slanted screen decks may be positioned and removably coupled in any suitable manner. For example, some portable, interchangeable slanted screen decks may be configured similar to the reducer grate decks previously described to include at least one catch member that couples to a horizontal bar between the upper end portions of the upright support members. Alternatively, other portable, interchangeable slanted screen decks may each be configured with a lip extending around the perimeter of the slanted screen deck. The lip may fit around each of the upper ends of the upright front and back supports for example when the interchangeable slanted screen deck is installed. Various locking mechanisms for holding the portable, interchangeable slanted screen decks in place may also be provided.

Further implementations are within the CLAIMS.

### C. Specifications, Materials, Manufacture, and Assembly

It will be understood that material separator implementations are not limited to the specific components disclosed herein, as virtually any components consistent with the intended operation of a material separator implementation may be utilized. Accordingly, for example, although particular components material separator implementations are disclosed, such components may comprise any shape, size, style, type, model, version, measurement, concentration, material, quantity, and/or the like consistent with the intended operation of a material separator implementation. Implementations are not limited to uses of any specific components, provided that the components selected are consistent with the intended operation of a material separator implementation.

Accordingly, for the exemplary purposes of this disclosure, the components defining any material separator implementation may be formed of any of many different types of materials or combinations thereof that can readily be formed into shaped objects provided that the components selected are consistent with the intended operation of a material separator implementation. For example, the components may be formed of: polymers; composites; metals, such as titanium, iron, steel, carbon steel, alloy steel, tool steel, stainless steel, aluminum, any combination thereof, and/or other like materials; alloys; any other suitable material; and/or any combination thereof.

Additionally, for the exemplary purposes of this disclosure, components may be formed of metal tube or bar stock, plate stock, angle stock, channel stock, and the like. For example, the grate members may be square tubes (e.g., 2″×2″×¼″) or bars (e.g., 2″×2″), rectangular tubes or bars, or the like that are turned on their edges so that they have a substantially diamond shape in cross-section. Spacing between main deck grate members of one material separator implementation may be about 4″, while in other implementations spacing of virtually any dimension may be provided, such as about 1″ to about 12″ for example. Spacing between reducer deck grate members and main deck grate members may be of virtually any dimension (e.g. about ¼″ to about 11″) subject to the spacing of main deck grate members.

Furthermore, the components defining any material separator implementation may be purchased pre-manufactured or manufactured separately and then assembled together. However, any or all of the components may be manufactured simultaneously and integrally joined with one another. The various implementations may be manufactured using conventional procedures as added to and improved upon through the procedures described here. Accordingly, manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. Components that are manufactured separately may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

### D. Use

Material separator implementations are particularly useful for the separation and recycling of excavated material. However, implementations are not limited to uses relating to the foregoing. Rather, any description relating to the foregoing is for the exemplary purposes of this disclosure, and implementations may also be used with similar results for a variety of other applications and to sort all forms of aggregate materials, including stone, rubble, soil, gravel, sand, and recyclable materials, including concrete, brick, cinderblock, asphalt, and other demolition debris.

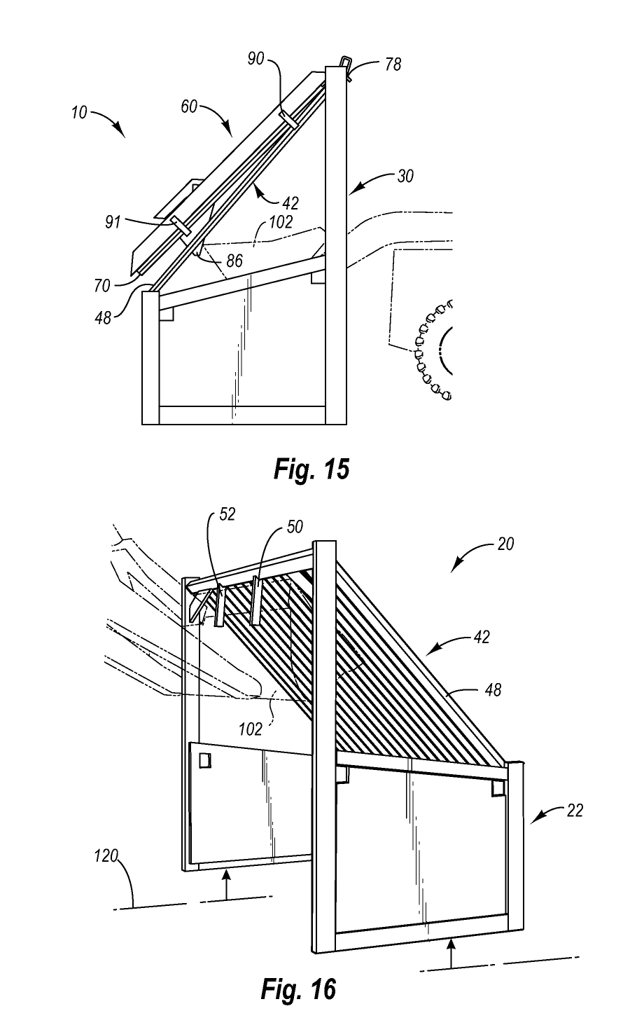

In describing the use of material separator implementations further and for the exemplary purposes of this disclosure, FIGS. 9-16 depict material separator 10 in conjunction with equipment 100 (e.g., a backhoe with a front end bucket).

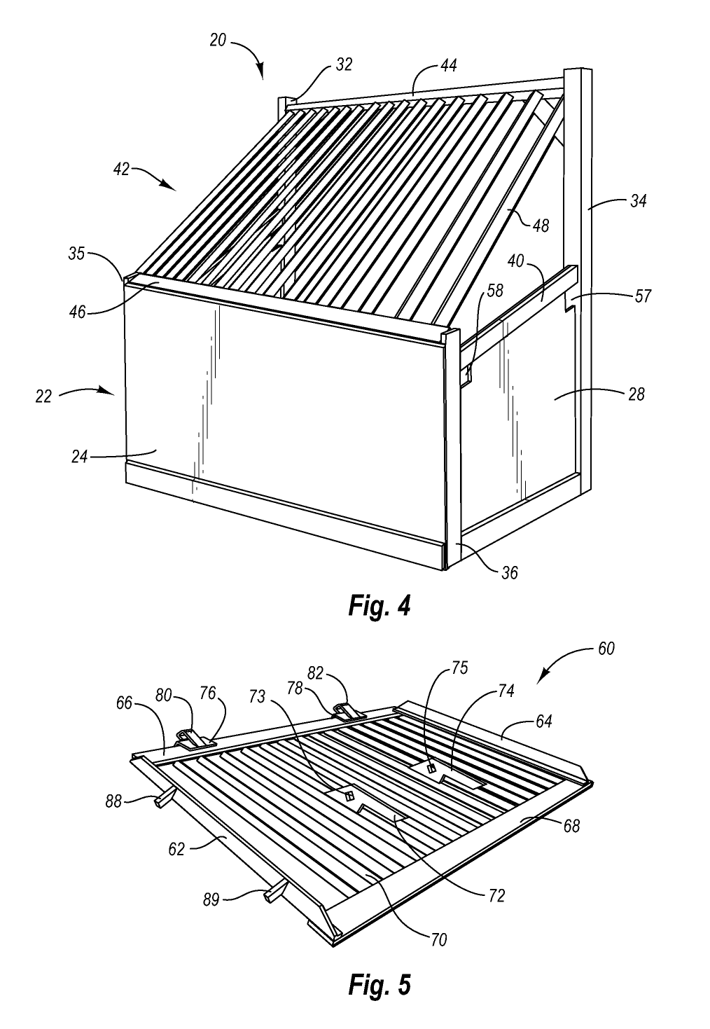

Referring to FIG. 4, during use, material to be separated may first be deposited on slanted grate deck 42 from the back of frame 20 (not shown). Smaller course material falls through slanted grate deck 42 into base 22 while larger course material falls off of slanted grate deck 42 and in front of front wall 24 of base 22. The recycled smaller course material may then be moved from open back 30 of base 22.

As specifically illustrated in FIGS. 9-10, portable reducer grate deck 60 having two external pick up members 72 and 74 may be lifted and transported by engaging the front end of bucket 102 of equipment 100 with pick up members 72 and 74. Turning to FIGS. 10-11, then reducer grate deck 60 is easily, properly, and automatically positioned on slanted grate deck 42 of frame 20 by seating tabs 88-91. Once reducer grate deck 60 is in position, it is held in place with respect to slanted grate deck 42 via catch members 76 and 78 pivotally engaging upper end member 44 of slanted grate deck 42. As shown in FIG. 7, grate members 70 mesh or nest between grate members 48 to form a unitary, flush decking.

Next, referring to FIGS. 12-14, the previous recycled smaller course material may be deposited on the unitary, flush decking formed by reducer grate deck 60 and slanted grate deck 42 thereby allowing even finer material to pass through to further separate and recycle the material. Material too coarse to pass through falls off of the decking in front of front wall 24 of base 22. The recycled smaller course material may then be moved from open back 30 of frame 22. Similarly, this finer material may continue to be further separated by changing out the reducer grate deck and replacing it with another reducer grate deck that will screen out even smaller material.

Turning to FIG. 15, if the decking formed by reducer grate deck 60 and slanted grate deck 42 becomes clogged with material 112 (clogging material 112 gets trapped between grate members 48 and 70 during separation of the material), bucket 102 is aligned with bumpers 84 and 86 and then equipment 100 is driven forward allowing bucket 102 to slidably engage internal bumpers 84 and 86 of reducer grate deck 60 and slidably push the free, non-pivoting end of reducer grate deck 60 upwards to clear or release clogged material 112. Equipment 100 is continued to be driven forward to allow bumpers 84 and 86 to slip inside of bucket 102 and reducer grate deck 60 to fall forcefully back into position, further shaking loose or crushing any lingering clogging materials 112. Additionally, during this entire process, bucket 102 is in a position to catch any released clogging material 112 that may fall through the decking so it can be reprocessed if desired or discarded, thereby preventing released clogging material 112 from mixing with/contaminating the previously separated finer material. Reducer grate deck 60 is easily, properly, and automatically re-positioned/re-seated back on slanted grate deck 42 by seating tabs 88-91, which keep reducer grate deck 60 centered with slanted grate deck 42 so as to not change the spacing between grate members 48 and 70 and ultimately the size of screened material.

Referring to FIG. 16, in order to transport and move frame 20, or for that matter the entire material separator 10, bucket 102 may engage lift members 50 and 52 by contacting the bottom side of slanted grate deck 42 such that lift members 50 and 52 reside outside bucket 102 and adjacent to a back edge of bucket 102. This engagement temporarily secures frame 20 to bucket 102 when frame 20 is lifted from ground 120 and moved.

1. A material separator comprising:
a frame comprising a base supporting a slanted grate deck; and
at least one reducer grate deck removably and pivotally coupled to the slanted grate deck.

2. The material separator of claim 1, wherein the reducer grate deck comprises two opposite side members, two opposite end members, and a plurality of grate members located between the opposite end members.

3. The material separator of claim 2, wherein the slanted grate deck has two opposite end members and a plurality of grate members located between the opposite end members, and wherein the grate members of the reducer grate deck are one of:
positioned above the grate members of the slanted grate deck;
nested between the grate members of the slanted grate deck to form a substantially unitary, flush decking; and
nested between the grate members of the slanted grate deck to form a unitary, flush decking.

4. The material separator of claim 3, wherein the grate members of the reducer grate deck and the grate members of the slanted grate deck are substantially diamond shape in cross-section.

5. The material separator of claim 3, wherein the grate members of the reducer grate deck are of a different size than the grate members of a slanted grate deck.

6. The material separator of claim 1, wherein the reducer grate deck is removably and pivotally coupled to the slanted grate deck by at least one catch member removably and pivotally engaging the upper end member of the slanted grate deck.

7. The material separator of claim 6, wherein the at least one catch member is one of:
two spaced apart catch members coupled to and extending from the upper end member of the reducer grate deck;
a plurality of spaced apart catch members coupled to and extending from the upper end member of the reducer grate deck;
one long catch member coupled to and extending from the upper end member of the reducer grate deck, the catch member extending along a substantial portion of the upper end member of the reducer grate deck; and
at least one catch member integrally joined with the upper end member of the reducer grate deck.

8. The material separator of claim 6, wherein the at least one catch member is at least one angle catch member, one side coupled to the upper end member of the reducer grate deck and the other side engaging the upper end member of the slanted grate deck.

9. The material separator of claim 1, wherein the reducer grate deck further comprises at least one internal bumper.

10. The material separator of claim 9, wherein the at least one internal bumper comprises at least one angled internal bumper that is slidably engageable with moving equipment.

11. The material separator of claim 9, wherein the at least one internal bumper is coupled to a lower portion of at least one grate member of the reducer grate deck.

12. The material separator of claim 11, wherein the at least one internal bumper comprises two spaced apart internal bumpers coupled to lower portions of two different grate members of the reducer grate deck.

13. The material separator of claim 2, wherein at least one seating tab coupled to each of the opposite side members of the reducer grate deck.

14. The material separator of claim 13, wherein each at least one seating tab extends outwardly at a downward angle from the side member.

15. The material separator of claim 13, wherein the at least one seating tab comprises two pairs of spaced apart seating tabs, each pair coupled on a different side member.

16. The material separator of claim 1 further comprising at least one external pick up member coupled to the reducer grate deck.

17. The material separator of claim 1 further comprising two lift members extending downwardly from an upper end portion of the slanted grate deck and a cross member removably coupled to free ends of the lift members.

18. The material separator of claim 1, wherein the base comprises a front wall, two opposite side walls, and an open back.

19. The material separator of claim 18, wherein the front wall comprises a double plated front wall having an inside wall plate and an outside wall plate.

20. The material separator of claim 18, wherein the two side walls each comprise at least one rigging member.

21. A material separator comprising:
a frame comprising:
a base comprising:
a front wall and two opposing side walls, the two side walls each comprising at least one rigging member;
two upright back supports, one extending upward from a back end of one sidewall and the other extending upward from a back end of the other sidewall; and
a slanted grate deck extending from upper portions of the upright supports down to an upper portion of the front wall.

22. The material separator of claim 21, wherein the at least one rigging member comprises a pair of spaced apart rigging members at an upper portion of each side wall

23. The material separator of claim 22, wherein the rigging members each comprise one of a hole, a ring, a channel section, and a hook.

24. The material separator of claim 23, wherein the rigging members each comprise a hole.

25. A material separator comprising:
a frame comprising:
a base comprising:
a front wall and two opposing side walls; and
two upright back supports, one extending upward at a back end of one sidewall and the other extending upward at a back end of the other sidewall;
a slanted grate deck extending from upper portions of the upright back supports down to an upper portion of the front wall;
two lift members extending downwardly from an upper end portion of the slanted grate deck; and
a cross member removably coupled to free ends of the lift members.

26. The material separator of claim 25, wherein the slanted grate deck further comprises an upper end member coupled to and separating upper portions of the upright back supports, and wherein the lift members are located spaced apart along the upper end member between the upright back supports.

27. The material separator of claim 25, wherein the slanted grate deck further comprises a plurality of grate members, and wherein the two lift members are located on upper portions of two separate grate members respectively.

28. A method for separating material, the method comprising:
positioning a frame having a base and a slanted grate deck on a ground;
removably and pivotally placing a removable reducer grate deck on the slanted grate deck;
depositing excavated material on the removable reducer grate deck such that the material is separated by passing through both the removable reducer grate deck and the slanted grate deck; and
releasing clogged material between grate bar members of the reducer grate deck and the slanted grate deck by engaging at least one internal bumper of the reducer grate deck with the moving equipment to push a free, non-pivoting end of the reducer grate deck upwards to release the clogged material.

29. The method of claim 28, wherein the step of releasing clogged material comprises releasing clogged material between grate bar members of the reducer grate deck and the slanted grate deck by slidably engaging at least one internal bumper of the reducer grate deck with the moving equipment to slidably push a free, non-pivoting end of the reducer grate deck upwards to release the clogged material.

30. The method of claim 29, wherein the step of releasing clogged material further comprises continuing to drive the moving equipment forward past the at least one bumper so that the reducer grate deck falls back into position further shaking loose or crushing any remaining clogged materials.

31. The method of claim 29, wherein the step of releasing clogged material further comprises collecting released clogged material that falls through the reducer grate deck and the slanted grate deck with the moving equipment.

32. The method of claim 30, wherein the step of releasing clogged material further comprises automatically re-positioning the reducer grate deck back on the slanted grate deck as it falls back using at least one seating tab located on each side member of the reducer grate deck.

33. The method of claim 28, wherein the step of removably and pivotally placing comprises removably and pivotally placing a removable reducer grate deck on the slanted grate deck by engaging a pair of spaced apart external pick up members with moving equipment.

34. The method of claim 28, wherein the step of removably and pivotally placing comprises removably and pivotally placing a removable reducer grate deck on the slanted grate deck by automatically positioning the reducer grate deck on the slanted grate deck using at least one seating tab located on each side member of the reducer grate deck.

35. The method of claim 28, wherein the step of removably and pivotally placing further comprises holding the removable reducer grate deck on the slanted grate deck by at least one catch member.

36. The method of claim 28, wherein the step of removably and pivotally placing further comprises one of:
positioning grate members of the reducer grate deck in a raised position above grate members of the slanted grate deck;
nesting grate members of the reducer grate deck between grate members of the slanted grate deck to form a substantially unitary, flush decking; and
nesting grate members of the reducer grate deck between grate members of the slanted grate deck to form a unitary, flush decking.
